(19) United States
(12) Patent Application Publication
(10) Pub. No.: US 2010/0102008 A1
(43) Pub. Date: Apr. 29, 2010

(54) BACKPRESSURE REGULATOR FOR SUPERCRITICAL FLUID CHROMATOGRAPHY

(76) Inventor: Herbert J. Hedberg, N. Attleboro, MA (US)

Correspondence Address: CESARI AND MCKENNA, LLP, 88 BLACK FALCON AVENUE, BOSTON, MA, 02210, US

(21) Appl. No.: 12/606,673

(22) Filed: Oct. 27, 2009

Related U.S. Application Data
(60) Provisional application No. 61/108,582, filed on Oct. 27, 2008.

(51) Int. Cl. B01D 15/18; B01D 15/40

(52) U.S. Cl. 210/741; 210/90

(57) ABSTRACT

This disclosure describes an implementation of a backpressure regulator (BPR) device which is a generally required system component to accomplish supercritical fluid chromatography (SFC). This particular BPR embodiment utilizes a magnetostrictive or piezo-stack displacement transducer to modulate a variable restriction orifice to maintain constant upstream pressure. Also, an example is provided of a repurposed commercially available common rail fuel injector from the automotive industry to serve as the variable restriction element of the BPR.

### CROSS-REFERENCE TO RELATED APPLICATIONS

The present application claims the benefit of U.S. Provisional Patent Application Ser. No. 61/108,582, which was filed on Oct. 27, 2008, by Herbert J. Hedberg for a “Backpressure Regulator for Supercritical Fluid Chromatography Using ‘Common Rail’ Fuel Injector” and is hereby incorporated herein by reference.

### BACKGROUND OF THE INVENTION

1. Field of the Invention

The present disclosure relates to a backpressure regulator device that maintains constant upstream pressure in supercritical fluid chromatographic (SFC) systems.

2. Background Information

SFC systems perform a chemical separation in which, generally, liquefied CO₂ plus an organic modifier are the mobile phase. In order to maintain the CO₂ as a liquid, as it passes through the pump, injector, column and detector modules of an SFC system, a BPR (backpressure regulator) may be installed in the flow path after the detector. The BPR typically contains a variable flow restriction component and an upstream pressure transducer that are used together to maintain a constant user defined pressure (typically 1,500 psi) immediately after the system detector. The outlet of the BPR is usually heated to prevent the adiabatic cooling of the expanding CO₂ gas from forming dry ice that blocks the flow path. Depending upon user applications and requirements, the eluant flow from the BPR may be collected or directed to a suitable fraction collector to isolate the individual separated compounds in discrete collection containers.

U.S. Pat. No. 6,358,414 describes a typical BPR implementation utilizing a stepper motor driving a lead screw attached to and driving a needle in and out of a valve seat. The positioning of the needle in the valve seat creates more or less flow restriction and, thus, the desired backpressure. In this way, a means is provided for an embedded microprocessor controller to modulate the eluant flow to hold the system pressure constant.

The complexity and the cost of the stepper motor-based BPR is high due to 30 to 50 moving parts, and such a BPR system may have reliability and maintenance issues. Moreover, there is a time delay from a measured error signal through to the stepper motor, lead screw arrangement to a corrected backpressure. Time delays may allow pressure fluctuations that may adversely affect chromatographic results.

### SUMMARY OF THE INVENTION

The present disclosure provides a backpressure regulator (BPR) and a method for regulating backpressure in the flow path of a super critical chromatographic system.

The method includes setting a desired pressure; typically 1500 psi just after the chromatographic detector. The pressure in the flow path is measured and compared to the set pressure. If there is a pressure difference, a computer controller generates a programmable voltage on a piezo electric stack, or a magnetostrictive device, that is attached to a piston that is located at a seal with an aperture that is in the flow path downstream from where the pressure is being measured. The programmable voltage activates the piezo electric stack to displace (to enlarge or reduce its size) and drives the attached piston to control the size of the aperture in the flow path that changes the measured pressure in a manner that reduces the pressure difference. In some applications the piezo electric stack may be made to be chromatographically benign and formed to comprise the piston.

A computer controller is provided with a processor, memory, input/output and other such hardware along with software to perform the measurements, monitoring and activation needed for the SFC system.

Since the flowing fluid is typically CO₂, the system must be cooled, and the computer controller may be arranged to control the cooling system. Moreover, as the CO₂ exits the system, there may be adiabatic expansion and corresponding cooling that may form dry ice blocking the flow exits. The computer controller may be arranged to measure the temperature where the CO₂ exits the system and drive a heater to prevent any dry ice from forming.

It was found that a common rail automotive fuel injector may be modified with chromatographic fixtures and be used as the piezo electric stack, piston and seal of the BPR.

The present invention provides a BPR that controls the pressure at the pressure sensor, but it thereby controls the flow pressure upstream to pump.

The present disclosure provides a number of advantages over the prior art. There are few moving parts, the reaction time is relatively quick, and, when operated by a DC voltage, it dissipates virtually no power.

### BRIEF DESCRIPTION OF THE DRAWINGS

The invention description below refers to the accompanying drawings, of which:

FIG. 1 is a block diagram of a SFC system; and

FIG. 2 is a block schematic of a backpressure regulator.

### DETAILED DESCRIPTION OF AN ILLUSTRATIVE EMBODIMENT

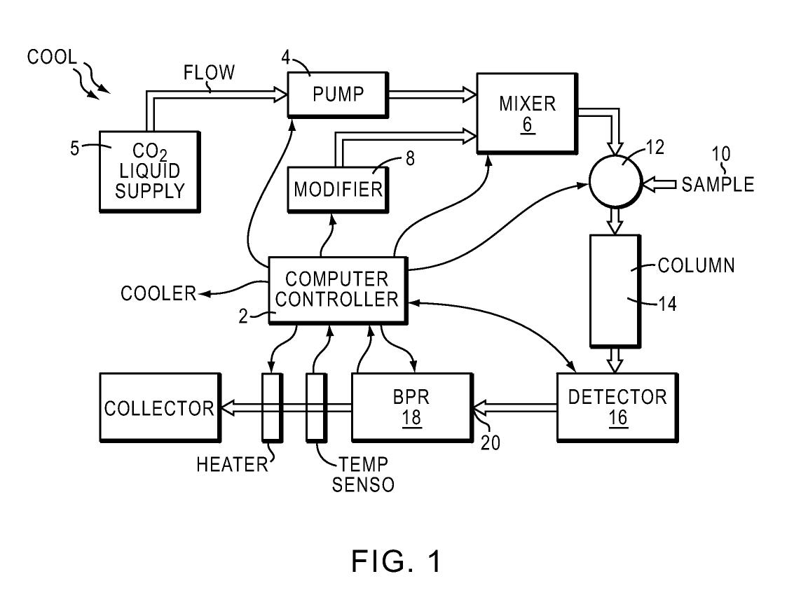

FIG. 1 is a SFC system block diagram. The components are similar to those found in traditional liquid chromatographic systems. A computer controller system 2 container a processor, memory, input/output and other hardware, and programming to carry out all the control, monitoring and measuring associated with a SFC system.

A pump 4 draws liquid CO₂ 5 from a supply and mixes 6 it with a modifier 8. The CO₂ flow rate and the modifier material and quantity are selected for the specific application. A sample 10 is injected 12 into the flow stream and passes through a separation column 14. The components in the sample separate in the column and elute at different times from the column. A detector 16 monitors the flow and outputs a signal as the sample components pass through it. Since the pressure variations in the system may cause errors, a backpressure regulator 18 receives the flow from the detector 16 and maintains, via a feedback loop, a constant pressure at a pressure detector located at the BPR. A typical pressure setting is about 1500 psi.

SFC systems are found in, but not limited to: petro chemical, polymer, environmental, food, pharmaceutical and natural product applications.

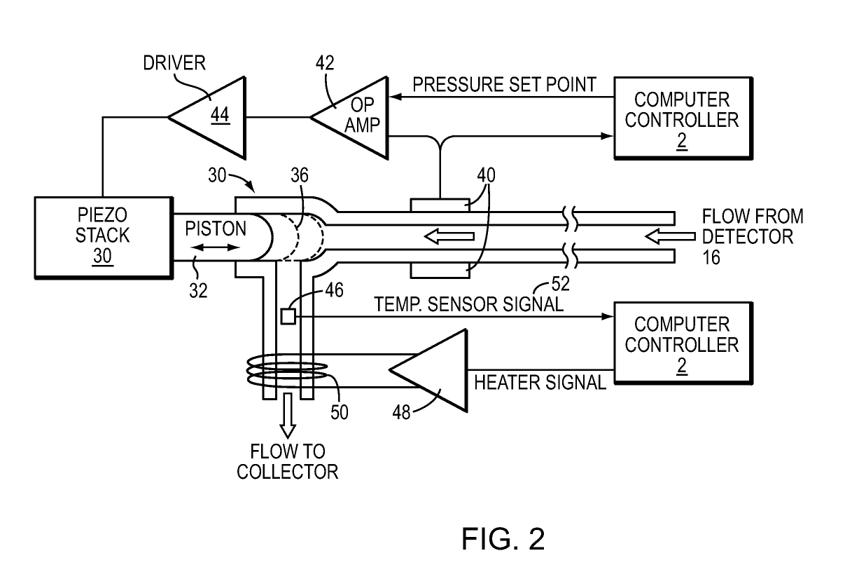

FIG. 2 illustrates a backpressure regulator for maintaining constant pressure in an SFC instrument. In this case, a voltage/current-to-displacement transducer such as a magnetostrictive device or a piezo stack 30 drives a piston 32 that modifies the effective orifice opening 36. The eluant flow 38 through the controlled orifice 36 controls the backpressure at a smooth walled pressure transducer 40.

The smooth walled pressure sensor 40 measures pressure prior to the orifice 36 downstream from the detector 16. At constant flow, controlling the pressure just before the orifice in fact controls the pressure further back up the flow path to the pump 4. The measured pressure is input to an operational amplifier 42 with the other input generated by the computer controller 2. The computer controller outputs a desired set pressure at the pressure sensor 40 and the operational amplifier 42 operates, via voltage driver 44, to drive the piezo electric stack 30 (or a magnetostrictive device) and the attached piston 32 change the pressure reading from the pressure sensor 40 to balance the operational amplifier inputs. The voltage driver 44 may be a programmable power supply with a range of output voltages that match the piezo electric stack capabilities. For example, in an application, zero volts may cause the piezo electric stack/piston 32 combination to completely close the orifice 36 while 190V opens the orifice 36. The size of the orifice opening may be set to encompass the desire range of backpressures at the pressure sensor 40. The negative feedback system of the sensor 40 to the position of the piston 32 is designed to maintain a stable pressure, typically 1500 psi, at the pressure sensor 40.

Similar operation as just described occurs when a magnetostrictive device replaces the piezo electric stack 30.

Since the mobile phase is liquid CO₂, which is cold, the expansion of the CO₂ after the orifice 36 may cause ice to build up downstream 46 from the orifice and block the exit path. The temperature at the exit 46 may be measured 52, and the heater driver 48 and coil may be actuated to maintain a desired temperature at the exit tube.

The resulting assembly has far fewer components, higher reliability, and lower cost than the prior art BPR's. Also, the performance may be far superior to that of a stepper motor or solenoid solution because of the quicker response time of the piezo electric stack.

A commercially available common rail automobile fuel injector may be modified to operate as part of a BPR in a SCF system. One such type of fuel injector is that found in the 2009 BMW 335i. This injector utilizes a piezo electric stack to open or close the flow path. The inlet fitting to the fuel injector must be replaced by a low volume, chromatographic friendly fitting. The outlet fitting of the fuel injector provides a mist to the automobile cylinder, and so this fitting must be replaced with stainless steel chromatographic tubing with the coiled heater wire 50. The range of flow through the automobile fuel injector modified as suggested is from zero to up to 2 liters per minute with the piezo electric drive from 0V to 190V, respectively.

What is claimed is:

1. A backpressure regulator located in the flow path of a super critical chromatographic system just after a detector, the backpressure regulator comprising:
a tube carrying super critical fluid from the detector;
a seal at the end of the tube; the seal having an aperture allowing flow therethrough;
a piston positioned with respect to the seal to restrict the flow through the aperture,
a piezo electric stack configured to drive the piston relative to the seal, wherein, when the piston is seated in the seal, flow through the aperture stops, and, when the piston is not seated in the seal, flow occurs through the aperture;
a programmable voltage connected to the piezo electric stack, wherein the stack moves the piston when the programmable voltage is changed;
a pressure sensor that outputs a pressure signal, located in the flow upstream from the seal;
a controller that accepts the pressure signal and drives the programmable voltage to position the piston relative to the seal such that the flow through the tube and thus the pressure at the pressure sensor changes.

2. The backpressure regulator of claim 1 further comprising:
a set pressure value resident in the controller, wherein the controller modifies the programmable voltage until the pressure signal equals the set pressure value.

3. The backpressure regulator of claim 2 wherein the set pressure is 1500 psi.

4. The backpressure regulator of claim 1 further comprising:
a temperature sensor, that outputs a temperature signal, located in the flow stream after the seal;
a set temperature value resident in the controller;
a heater located proximate the temperature sensor, wherein the controller accepts the temperature signal and outputs a signal to the heater such that temperature signal equals the set temperature value.

5. The backpressure regulator of claim 1 wherein the piezo electric stack, the piston and the seal comprise a common rail automobile fuel injector having a first end with a chromatographic fitting connected to the tube and a second end with a chromatographic fitting connected to the temperature sensor and heater.

6. A method for regulating pressure in the flow path of a super critical chromatographic system, the method comprising:
setting a desired pressure;
measuring pressure in the flow path as the flow exits a chromatographic detector, and in response thereto,
comparing the measured pressure and the set pressure and if there is a difference,
activating a piezo electric stack, wherein a piston attached to the piezo electric stack opens and closes an aperture in the flow path downstream from where the pressure is being measured, wherein the size of the aperture changes the measured pressure in a manner that reduces the difference.

7. The method of claim 6 wherein a magnetostrictive device replaces the piezo electric stack.
